(19) United States
(12) Patent Application Publication
(10) Pub. No.: US 2003/0190203 A1
(43) Pub. Date: Oct. 9, 2003

(54) High frequency tooth pass cutting method

(76) Inventors: Troy D. Marusich, Eden Prairie, MN (US); Kerry J. Marusich, Eden Prairie, MN (US)

Correspondence Address: Dorsey & Whitney LLP, Intellectual Property Department, Suite 1500, 50 South Sixth Street, Minneapolis, MN, 55402-1498, US

(21) Appl. No.: 10/408,966

(22) Filed: Apr. 8, 2003

Related U.S. Application Data
(60) Provisional application No. 60/370,777, filed on Apr. 8, 2002.

(51) Int. Cl. B23C 1/00

(52) U.S. Cl. 409/132

(57) ABSTRACT

A method for cutting metal includes providing a rotating cutting tool and making a first cut in the material using a first tooth of the cutting tool, such that an amount of heat is conducted into the material. A second cut is made in the material using a second tooth of the cutting tool, before the heat dissipates from the material. The time between the first cut and the second cut is such that the heat softens the material and allows the second tooth to more easily cut the material.

### CROSS-REFERENCE TO RELATED APPLICATION(S)

This application claims priority to U.S. provisional patent application No. 60/370,777 filed Apr. 8, 2002, the entire content of which is incorporated herein by this reference.

### FIELD OF THE INVENTION

The present invention relates to an apparatus and method of cutting materials utilizing a rotating cutting tool. More specifically, the invention includes a cutting process that uses the heat generated by the cutting process to more efficiently cut materials.

### BACKGROUND OF THE INVENTION

In the process of metal cutting, when a tool cuts a metal, heat is generated by shear stresses, plastic deformation, and friction in the cutting region. Generally this heat is distributed into three regions. One portion flows into the tool, another portion flows into the chip, and the third portion is conducted into the workpiece. The surface of the workpiece is thermally softened by this third portion of heat. The heat that flows into the workpiece is conducted from the surface into the bulk, and the rate of this heat transfer depends on the thermal properties of the workpiece.

A rotating cutting tool, such as a milling cutter, includes one or more teeth that cut material in a progressive manner. Between each cutting path of successive teeth, heat is conducted into the workpiece and is lost to the environment. For example, the heat may be conducted away into the workpiece-holding device or may be convected into the surrounding environment. Accordingly, the next tooth is unable to take advantage of the thermal softening caused by the previous tooth. There is a need in the art for an improved cutting system that cuts the thermally softened material, which requires lower specific cutting forces and results in lower power consumption, improved tool life, and improved material removal rates.

### BRIEF SUMMARY OF THE INVENTION

The present invention, according to one embodiment, is a method for cutting metal including providing a rotating cutting tool, making a first cut in the material using a first tooth of the cutting tool, such that an amount of heat is conducted into the material, and making a second cut in the material using a second tooth of the cutting tool, before the heat dissipates from the material, such that the heat softens the material and allows the second tooth to more easily cut the material. In one embodiment, the time between cutting passes is determined using the following equation:

T=T₍ₜ₌₀₎+[Tₛ−T₍ₜ₌₀₎]{1−erf[X/√4αt]}

Where, T is a transient temperature, T₍ₜ₌₀₎ is an initial temperature, Tₛ is a temperature after the first cutting pass by the cutting tool, erf is an error function, X is a distance into the material from a top surface, α is a thermal diffusivity of the material, and t is the time between the first cut and the second cut. The result of cutting a material using the HFTP regime is a reduction in specific cutting forces, high utilization of heat, lower peak tool temperatures, higher tool life, and improved material removal rates.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a flowchart showing a method of cutting or milling materials according to the present invention.

FIGS. 2A-2D show various stages of the workpiece cutting process.

FIG. 3 shows a workpiece undergoing a multiple tooth pass cutting process, including a corresponding thermal profile of the cutting teeth and the workpiece, according to one embodiment of the present invention.

FIG. 4 shows a workpiece undergoing a multiple tooth pass cutting process, including a corresponding thermal profile of the cutting teeth and the workpiece, according to another embodiment of the present invention.

FIG. 5 shows a schematic view of a cutting tool according to one embodiment of the present invention.

FIG. 6 shows an isometric view of a cutter according another embodiment of the present invention.

FIG. 7 shows a sectional view of a cutter in a plane perpendicular to the central axis according to an embodiment of the present invention.

### DETAILED DESCRIPTION

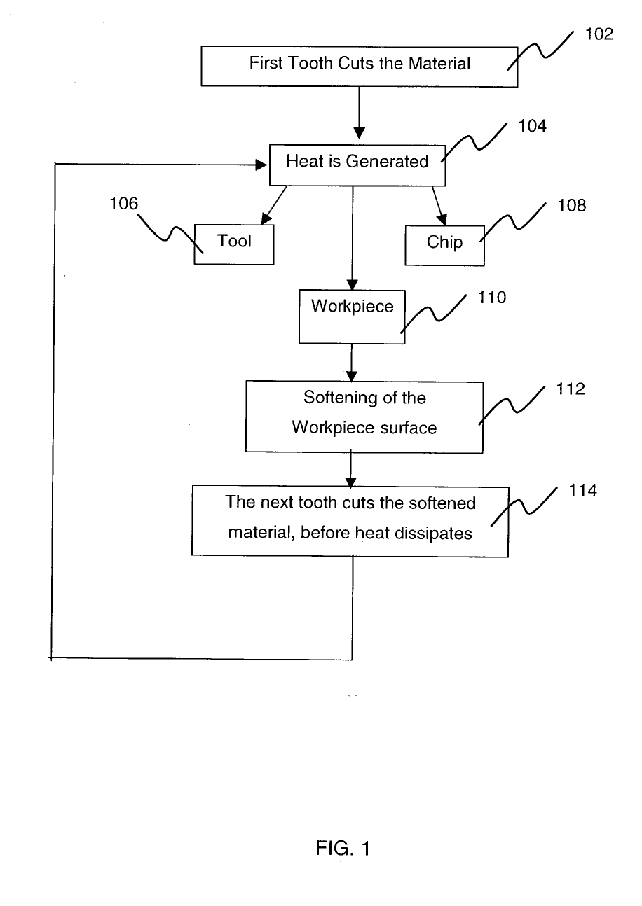

FIG. 1 is a flow chart showing a method 100 of cutting materials according to the present invention. As shown in FIG. 1, the first tooth of a multiple tooth cutting tool cuts the workpiece (block 102). This cutting process generates heat caused by forces between the cutting tool and the workpiece (block 104). Generally, this heat is distributed into three portions. One portion of the heat goes into the cutting tool (block 106), another portion goes into the chip or waste created by the cut (block 108), and the remaining portion goes into the workpiece (block 110). The heat conducted into the workpiece softens the surface of the workpiece (block 112). Depending on the thermal properties of the workpiece material, this heat from the surface gets transported into the bulk of the workpiece at a particular rate of conduction. The next tooth then cuts the workpiece before too much of the heat is transferred into the bulk of the workpiece (block 114). This process results in cutting material in a high-frequency tooth pass (“HFTP”) regime.

The HFTP regime takes advantage of the thermal properties of materials, especially stronger materials such as titanium and titanium alloys, steel, alloy steels, and other non-ferrous metals. According to one embodiment of the present invention, a suitable time period between successive tooth passes is calculated using the following one-dimensional heat transfer equation:

T=T₍ₜ₌₀₎+[Tₛ−T₍ₜ₌₀₎]{1−erf[X/√4αt]}

Where, T is a transient temperature, T₍ₜ₌₀₎ is an initial temperature, Tₛ is a temperature after the first cutting pass by the cutting tool, erf is an error function, X is a distance into the material from a top surface, α is a thermal diffusivity of the material, and t is the time between the first cut and the second cut. The result of cutting a material using the HFTP regime is a reduction in specific cutting forces, high utilization of heat, lower peak tool temperatures, higher tool life, and improved material removal rates.

This heat transfer equation is used to calculate a suitable time between successive cutting actions. In one embodiment, the time between cutting passes is from about 0.8 to about 1.2 multiplied by t in the above equation. In another embodiment, the time between cutting passes is from about 0.9 to about 1.1 multiplied by t in the above equation. In yet another embodiment, the time between cutting passes is about t, as determined by the above equation. This time is then used to determine a frequency at which the material of a workpiece is cut. The frequency of the cutting tool or cutter is defined as the number of times a material is cut in a second. Thus, frequency is the number of tooth passes per second. The cutter frequency depends on the combination of the revolutions per minute (“RPM”) of the cutting tool and the number of teeth per around its circumference.

In one embodiment, frequency of the cutting tool for the HFTP regime is at least about 95 tooth-passes-per-second. This frequency can be used for cutting different materials, including titanium and titanium alloys, steel and steel alloys, and other non-ferrous metals and materials.

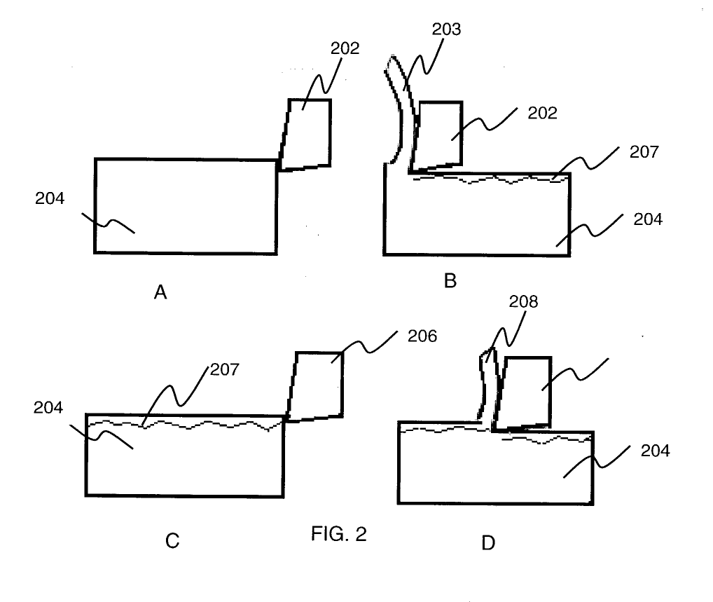

FIGS. 2A-2D show the effect of applying the HFTP regime to a workpiece. As shown in FIG. 2A, a first tooth 202 of the cutting tool enters the workpiece 204. In this illustration, the tool is moving from right to left of the view as it progresses into the cut. In FIG. 2B, the first tooth 202 finishes cutting and exits the workpiece 204 at the left. In the cutting process, a chip 203 is generated. Also, due to the cutting action, heat is generated and gets distributed into the tool 202, the chip 203 and the workpiece 204. The transfer of heat into the workpiece 204 is shown by line 207 in FIG. 2B. FIG. 2C shows the start of the cutting process by a second tooth 206. As the cutting process is based on to the HFTP regime, accurate time delay exists between successive tooth passes. In FIG. 2C, the resulting heat 207 generated from the cutting action of first tooth 202 is shown near the surface of the workpiece 204. Because of this heat 207, the workpiece 204 material in the surface region remains softened. While this heat 207 remains on the surface of the workpiece 204, the second tooth 206 enters the workpiece 204 and progresses into the cut. As shown in FIG. 2D, the second tooth 206 finishes cutting the workpiece 204 before the heat 207 dissipates. Chip 208 is generated as a result of the cutting action.

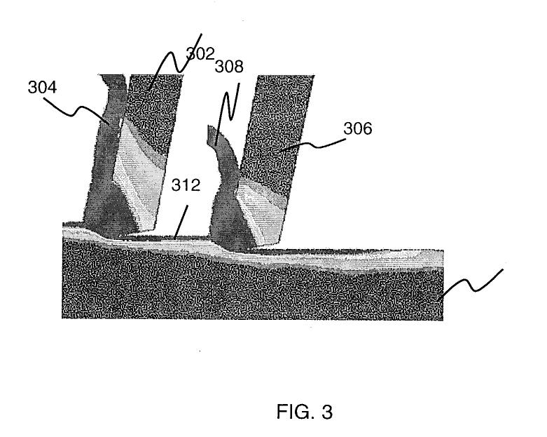

FIG. 3 shows another embodiment of cutting a workpiece according to the HFTP regime. As shown in FIG. 3, two cutting teeth 302 and 306 are simultaneously engaged in cutting a workpiece material 310. Heat is generated by the cutting action of the tooth 302, and is distributed into the tooth 302, the chip 304, and the workpiece 310. The heat that goes into workpiece 310 is represented by the lines 312. The second tooth 306 then follows the first tooth 302 within a suitable time period calculated using the above equation, to take advantage of the softening of the workpiece 310 caused by the heat 312.

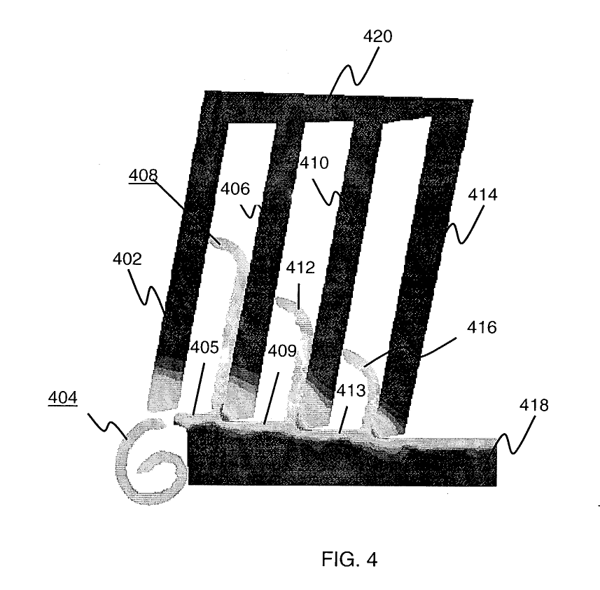

FIG. 4 shows yet another embodiment of cutting a workpiece according to the HFTP regime. As shown in FIG. 4, a cutting tool 420 has four cutting teeth 402, 406, 410, 414. The cutting tool 420 has a plurality of teeth but only four are shown for representation purpose. The spacing and time interval between these successive teeth is designed according to the HFTP regime, as detailed above. Heat generated by the cutting action of the tooth 402 is distributed into the tooth 402, the chip 404, the workpiece 418. This heat, which is shown by the line 405 on the workpiece, softens the material in front of the next tooth 406. As a result, the cutting forces experienced in cutting action by the tooth 406 will be smaller compared to that experienced by the first tooth 402. The heat generated by cutting action of tooth 406 is distributed into the tooth 406, the chip 408, and the workpiece 418. This heat, which is shown by the line 409, on the workpiece softens the material ahead of the next tooth 410. As a result, the cutting forces experienced in cutting action by the tooth 410 will be smaller compared to a workpiece that has not been softened. The heat generated by cutting action of tooth 410 is distributed into the tooth 410, the chip 412, and the workpiece 418. This heat, which is shown by the line 413, on the workpiece softens the material ahead of the next tooth 414. As a result the cutting forces experienced in cutting action by this tooth 414 will be smaller yet.

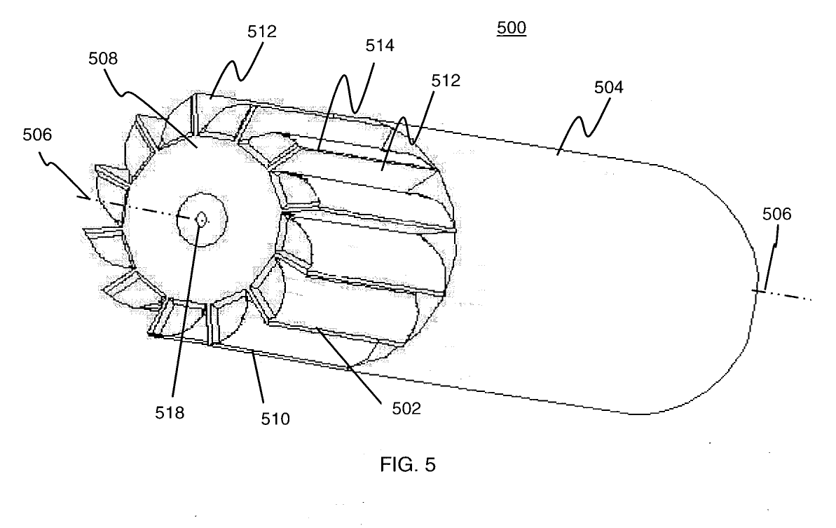

FIG. 5 shows a schematic view of a cutting tool 500 according to one embodiment of the present invention. The cutting tool 500 may be an end mill, face mill, or any other similar cutting tool. FIG. 5, for example, shows an end mill with a straight flute. The cutting tool 500 includes a cylindrical tool body 502 and a shank 504. This cylindrical body 502 may be a hollow or a solid body with an axis 506 passing through the center along the length of the body 502. The tool body 502 extends from the shank 504 to an end face 508. The cylindrical surface 510 is the surface between the end face 508 and the shank 504. The cylindrical surface 510 carries plurality of flutes or grooves 512. In one embodiment, the cylindrical surface 510 includes at least six grooves 512, which originate at the circumference of the end face 508 and run throughout the cylindrical surface 510 of the tool body 502. The flutes 512 may be straight or helical. For example, FIG. 5 shows twelve straight flutes 512. The flutes 512 may have different shapes depending on designs and application including but not limited to a parabolic flute shape.

A cutting edge 514 is formed by all outermost points on a flute 512, which are on the cylindrical surface. As known in the art, a face mill will also have cutting edges along points on flute running in radial direction on end face. The angle of helix which is defined by an angle between cutting edge 514 and central axis, may vary from 0 to 60 degrees. For example the cutting tool in FIG. 5 has straight flutes 512, so the angle of helix is zero. The flutes 512 may or may not be equidistant from each successive flute 512. A through hole 518 along the length of the cutter may be provided for air-blow or for coolant circulation to keep peak tool temperatures at lower levels. Additional holes may or may not be provided along flutes 512 so as to direct coolant or air in a way to assist chip evacuation, cooling the tool 500.

The cutting tool 500 material may be any of the tool steels in general, including, for example, high speed steels, solid carbide, tool steel with carbide coatings, or an indexable insert cutter. The cutting tool 500 may also be impregnated with different materials including, for example silicon carbide, aluminum oxide, diamond, cubic boron nitride, garnet, zirconia or similar abrasive materials. In one embodiment, the cutting tool 500 may have an edge preparation depending on the use. The edge preparations that can be used include a T-land, a sharp-edge radius, or a ground and honed edge. The tool 500 material may have a coating on it. The tool 500 may also have an air blow option for ease in chip removal and a coolant option for keeping the tool temperatures low.

The shank 504 is designed so that it is capable of insertion and securing into a spindle. Thus, the shank 504 could be of any shape and design suitable for a particular milling machine. The shank 504 designs may include a taper, a V-flange, or straight. As is known in the art, face mill does not have a shank. The shank 504 material may be similar to the tool 500 or may be different. For example, the shank 504 and the tool 500 may be made up of different materials and welded together to make a uniform single-body tool.

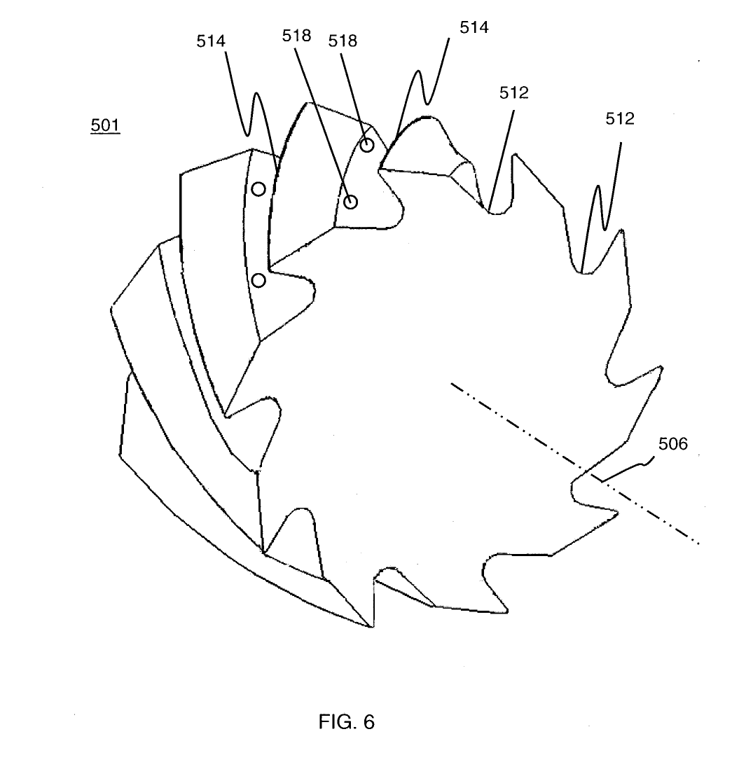

FIG. 6 shows an alternative embodiment of a cutting tool 501 having twelve flutes 512. As shown in FIG. 6, the flutes 512 have an angle of helix of twenty degrees. This cutter also has holes 518 to direct coolant onto the tool 501.

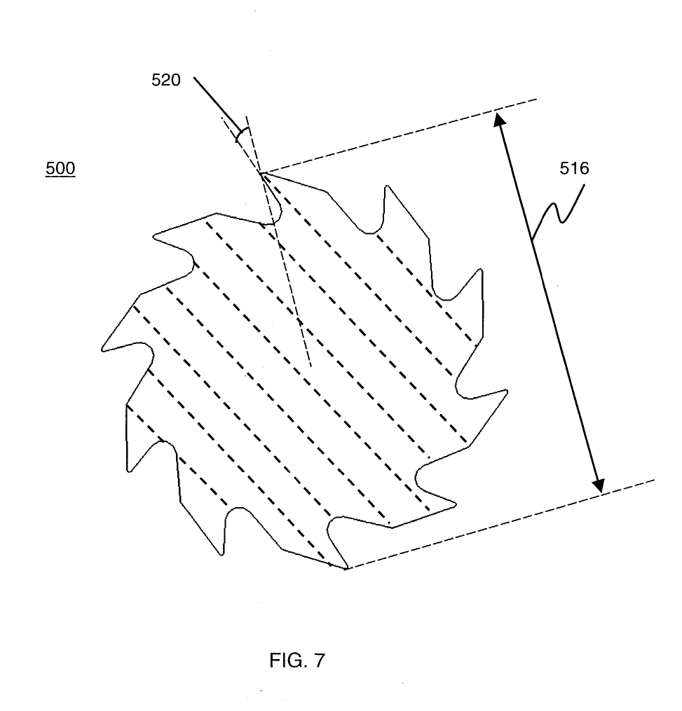

FIG. 7 shows a sectional view of the cutting tool 500. As shown in FIG. 7, the diameter of tool 500 is shown by the dimension 516. In one embodiment, the tool 500 diameter may vary from about 6 to about 300 mm, depending on the type of application. As shown in FIG. 7 an angle formed between plane of a flute and a radius of the tool 500 passing through the cutting edge in that plane is called radial rake angle 520. The tool 500 may have a range of radial rake angles from positive to negative.

Although the present invention has been described with reference to preferred embodiments, persons skilled in the art will recognize that changes may be made in form and detail without departing from the spirit and scope of the invention.

We claim:

1. A method of cutting a material comprising:
providing a rotating cutting tool;
making a first cut in the material using a first tooth of the cutting tool, such that an amount of heat is conducted into the material; and
making a second cut in the material using a second tooth of the cutting tool, before the heat dissipates from the material;
wherein the heat softens the material and allows the second tooth to more easily cut the material.

2. The method of claim 1 wherein a time between the first cut and the second cut is determined using the equation:
T=T₍ₜ₌₀₎+[Tₛ−T₍ₜ₌₀₎]{1−erf[X/√4αt]};
where: T is a transient temperature, T₍ₜ₌₀₎ is an initial temperature, Tₛ is a temperature after the first cutting pass by the cutting tool, erf is an error function, X is a distance into the material from a top surface, α is a thermal diffusivity of the material, and t is the time between the first cut and the second cut.

3. The method of claim 2 wherein the time is from about 0.8 to about 1.2 multiplied by t, as determined using the equation.

4. The method of claim 2 wherein the time is about t, as determined using the equation.

5. The method of claim 1 wherein the cutting tool is rotated at a rate sufficient to create a cutting frequency of about at least 95 teeth-per-second.

6. The method of claim 1 wherein the first tooth and the second tooth make simultaneous cuts in a first portion and a second portion of the material.

7. The method of claim 1 wherein the material is selected from the group including: titanium and titanium alloys, steel and steel alloys, and other non-ferrous metals.
